(19) United States
(12) Patent Application Publication
(10) Pub. No.: US 2019/0174733 A1
(43) Pub. Date: Jun. 13, 2019

(54) SHOCK LEADER SWIVEL

(71) Applicant: GOREE CO.,LTD., Seoul (KR)

(72) Inventor: Han Gyul JO, Seoul (KR)

(73) Assignee: GOREE CO.,LTD., Seoul (KR)

(21) Appl. No.: 16/301,404

(22) PCT Filed: Jun. 20, 2017
(86) PCT No.: PCT/KR2017/006479

§ 371 Date: Nov. 13, 2018

(30) Foreign Application Priority Data
Aug. 31, 2016 (KR) 20-2016-0005072

(51) Int. Cl. A01K 91/04; A44B 13/02

(52) U.S. Cl. CPC A01K 91/04; A44B 13/02

(57) ABSTRACT

A shock leader swivel according to a first embodiment of the present invention comprises: a shock leader portion, one end of which is coupled to a fishing line of a fishing rod, and which exhibits a tensile force; a swivel portion, one end of which is rotatably coupled to the other end of the shock leader portion so as to prevent the fishing line and the shock leader portion from being twisted; and a clip portion, one end of which is coupled to the swivel portion.

### TECHNICAL FIELD

The present invention relates to a shock leader swivel and more specifically, to a shock leader swivel capable of prevent a fishing line from being cut even without a shock leader connected to a fishing line of a fishing rod.

### DESCRIPTION OF THE RELATED ART

In general, a sinker, artificial bait etc. are connected to a fishing line of a fishing rod. The fishing line consists of polyethylene multi-filaments that are thin but strong. However, the fishing line is easily cut by an immediate shock when a large fish is snatched and when a fishing rod is cast. To solve this problem, a shock leader consisting of nylon or carbon is connected to a fishing line.

A plurality of strands of the shock leader are twisted and then connected to a fishing line and kept at a predetermined distance away from the fishing line. The fishing line is undone from the fishing line or wound around the fishing line so as to prevent the fishing line from being twisted and to prevent the fishing line from being cut due to an instant shock.

However, in terms of the above-described shock leader, a part where there is a knot or a part where there is a knot to which a sinker and artificial bait etc. are connected, on a fishing line and a shock leader, is cut due to an immediate shock that happens when a large fish is snatched.

Additionally, in terms of the above-described shock leader, a part connected with a fishing line is damaged by an instant shock or a part where there is a knot on a fishing line and a shock leader is damaged by an instant shock when heavy artificial bait is cast into the water so as to catch a large fish. Thus, the shock leader has to be re-connected to the fishing line.

Additionally, the fishing line consists of polyethylene multifilaments. When the fishing line is repeatedly twisted, the shock leader has a lowered restoring force. Thus, the shock leader has to be replaced with a new one after a certain period of time.

A plurality of strands of the above-described shock leader are twisted and then coupled to a fishing line. After being damaged or used for a certain period of time, the shock leader has to be replaced with a new one. In this case, replacing the shock leader with a new one is time and effort consuming.

As prior documents, there are South Korean Patent Laid-Open Publication No. 10-2015-0014004 etc.

### DETAILED DESCRIPTION OF THE INVENTION

### Technical Problems

As a means to solve the above-described problems, the present invention is directed to providing a shock leader swivel, which is provided with a shock leader portion having tensile force the same as maximum tensile forces of various sorts of fishing lines and coupled to a fishing line so as to prevent the fishing line and shock leader portion from being cut, and a swivel portion rotatably coupled to the shock leader portion so as to prevent a fishing line from being twisted, when a fish is snatched.

### Technical Solutions

A shock leader swivel according to the first embodiment of the present invention includes a shock leader portion one end of which is coupled to a fishing line of a fishing rod and has tensile force; a swivel portion one end of which is rotatably coupled to the other end of the shock leader portion so as to prevent the fishing line and the shock leader portion from being twisted; and a clip portion one end of which is coupled to the swivel portion.

Further, the shock leader portion includes a first coupling portion so as to connect one end thereof to the fishing line, a second coupling portion so as to connect the other end thereof to one end of the swivel portion, and an elastic body having tensile force may be provided between the first and second coupling portions.

Further, the elastic body is configured as a coil spring where a plurality of coils are wound, and the tensile force of the elastic body may be adjusted depending on the number of windings and the thickness of the coil.

Further, the swivel portion includes a first loop portion which is coupled to the second coupling portion; a second loop portion which is coupled to one end of the clip portion; and a body portion into which the first and second loop portions are rotatably inserted and coupled such that the first and second loop portions rotate at upper and lower portions of the body portion, wherein the body portion has a hollow inside, and includes first and second insertion holes at the upper and lower portions thereof such that the first and second loop portions are inserted into and coupled to the upper and lower portions of the body portion.

Further, the first loop portion includes a first coupling rim which is coupled to the second coupling portion and has an opening on one side thereof; a pair of first insertion pins that extend downwards from the opening and are inserted into the first insertion hole; and a first escape prevention pin in which one ends of the pair of first insertion pins extend inwards and are coupled to an outer edge of the first insertion hole so as to prevent the first loop portion from escaping from the inside of the body portion, and the second loop portion includes a second coupling rim which is coupled to one end of the clip portion and has an opening on one side thereof; a pair of second insertion pins that extend upwards from the opening and are inserted into the second insertion hole; and a second escape prevention pin in which one ends of the pair of second insertion pins extend inwards and are coupled to an outer edge of the second insertion hole so as to prevent the second loop portion from escaping from the inside of the body portion.

Further, the clip portion includes first and second opening portions whose ends on one side thereof are configured to be coupled to and separated from each other such that the inlet and outlet of the second loop portion are possible; a first extension portion which extends from one end of the first opening portion while the first extension portion stands because of a reduced perpendicular width thereof at one end of the first opening portion; a second extension portion which extends from one end of the second opening portion while the second extension portion stands because of a reduced perpendicular width thereof at one end of the second opening portion; and an elastic portion, where the other ends of the first and second extension portions are connected to each other, on which the second loop portion is mounted, and which has a round outer side so as to be elastic enough to couple the second opening portion to the first opening portion and separate the second opening portion from the first opening portion, wherein the first opening portion includes a catching hook which is bent inwards in multiple stages such that the second opening portion is coupled to and separated from the first opening portion, and the second opening portion includes a catching hole one end of which is curved outwards and is coupled to the catching hook of the first opening portion.

A shock leader swivel according to the second embodiment of the present invention includes a swivel portion one end of which is rotatably coupled to a fishing line of a fishing rod and which prevents the fishing line from being twisted; a shock leader portion which is coupled to the other end of the swivel portion and has tensile force; and a clip portion on end of which is coupled to the shock leader portion, wherein the swivel portion includes first and second loop portions such that one end of the swivel portion is coupled to the fishing line while the other end is coupled to one end of the shock leader portion, and a body portion into which the first and second loop portions are rotatably inserted into and coupled to upper and lower portions thereof and which is formed between the first and second loop portions, and wherein the shock leader portion includes a first coupling portion one end of which is coupled to the second loop portion, a second coupling portion the other end of which is coupled to one end of the clip portion, and an elastic body in which a plurality of coils are wound between the first and second coupling portions and which is configured as a coil spring having tensile force.

Further, the body portion has a hollow inside, and includes first and second insertion holes at the upper and lower portions thereof such that the first and second loop portions are inserted into and coupled to the first and second insertion holes, wherein the first loop portion includes a first coupling rim which is coupled to the fishing line and has an opening on one side thereof; a pair of first insertion pins that extend downwards from the opening and are inserted into the first insertion hole; and a first escape prevention pin in which one ends of the pair of first insertion pins extend inwards and are coupled to an outer edge of the first insertion hole so as to prevent the first loop portion from escaping from the inside of the body portion, and wherein the second loop portion may include a second coupling rim which is coupled to the first coupling portion and has an opening on one side thereof; a pair of second insertion pins that extend upwards from the opening and are inserted into the second insertion hole; and a second escape prevention pin in which one ends of the pair of second insertion pins extend inwards and are coupled to an outer edge of the second insertion hole so as to prevent the second loop portion from escaping from the inside of the body portion.

Further, the clip portion includes first and second opening portions whose ends on one side thereof are configured to be coupled to and separated from each other such that the inlet and outlet of the second coupling portion are possible; a first extension portion which extends from one end of the first opening portion while the first extension portion stands because of a reduced perpendicular width thereof at one end of the first opening portion; a second extension portion which extends from one end of the second opening portion while the second extension portion stands because of a reduced perpendicular width thereof at one end of the second opening portion; and an elastic portion, where the other ends of the first and second extension portions are connected to each other, on which the second coupling portion is mounted, and which has a round outer side so as to be elastic enough to couple the second opening portion to the first opening portion and separate the second opening portion from the first opening portion, wherein the first opening portion includes a catching hook which is bent inwards in multiple stages such that the second opening portion is coupled to and separated from the first opening portion, and the second opening portion includes a catching hole one end of which is curved outwards and is coupled to the catching hook of the first opening portion.

### Advantageous Effects

A shock leader swivel according to embodiments of the present invention is provided with a shock leader portion, which has tensile force the same as maximum tensile forces of various sorts of fishing lines, is coupled to a fishing line so as to effectively absorb the shock that happens when a fish is snatched and to prevent the fishing line and the shock leader portion from being cut, thereby making it possible to save time for the re-coupling of the fishing line and the shock leader portion when the fishing line is cut.

Further, when fishing tackle is cast into the water to catch a fish, a shock leader portion is deformed by tensile force so as to absorb the shock that happens when fishing tackle is cast, thereby preventing the fishing line from being cut.

Further, a swivel portion, rotatably coupled to a shock leader portion, can prevent a fishing line from being twisted when a fish is snatched and prevent damage done to the fishing line by the twist of the fishing line.

### BRIEF DESCRIPTION OF THE DRAWINGS

FIG. 1 is a view illustrating a state where a shock leader swivel according to the first embodiment of the present invention is coupled to a fishing line.

FIG. 2 is a view illustrating the shock leader swivel in FIG. 1.

FIG. 3 is a view illustrating the swivel portion in FIG. 1.

FIG. 4 is a view illustrating a shock leader swivel according to the second embodiment of the present invention.

FIG. 5 is a view illustrating the swivel portion in FIG. 4.

FIG. 6 is a view illustrating a state where the shock leader swivel in FIG. 1 is being used.

### MODE FOR CARRYING OUT THE INVENTION

Below, embodiments of the present invention will be described in detail with reference to the attached drawings such that one of ordinary skill in the art to which the present invention pertains can easily embody the present invention. However, the present invention may be modified in various forms and should not be limited to the embodiments set forth herein.

What is irrelevant to description of the present invention will be omitted such that the present invention is clearly described, and like reference numerals denote like or similar elements throughout the specification.

The thickness or the size of each element illustrated in the drawings may be exaggerated for the sake of convenience and clarity in description. Thus, the present invention should not be limited to what is illustrated in the attached drawings.

It should be understood that the terms “first”, “second” etc., are used herein only to distinguish one element from another element. Thus, in the following description of the present invention, the terms “first”, “second” etc. are not necessarily limited to order.

It will be further understood that throughout this specification, unless explicitly described to the contrary, the term “comprise” should imply the inclusion of any other element but not the exclusion of any other element.

Further, the terms “unit”, “means”, “portion”, “member” etc. set forth in this specification denote unit of a comprehensive configuration in at least one function or operation.

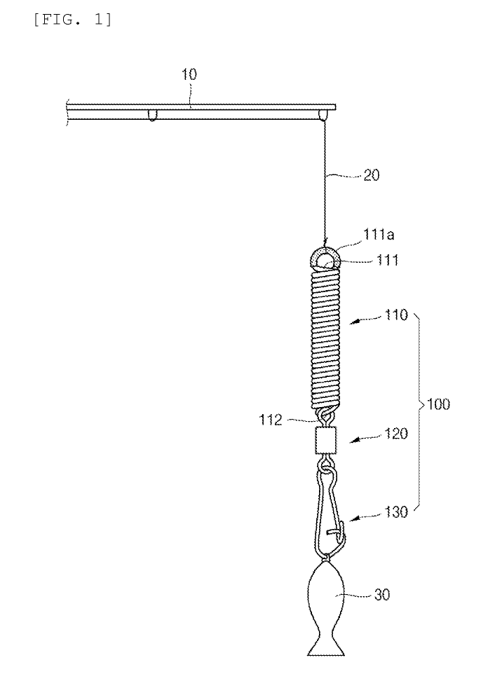

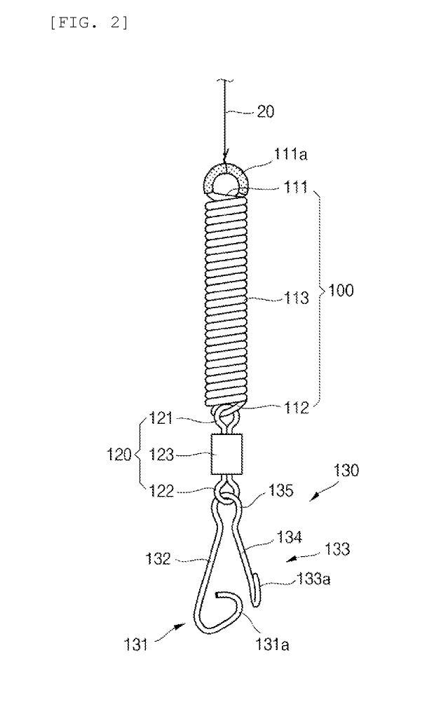

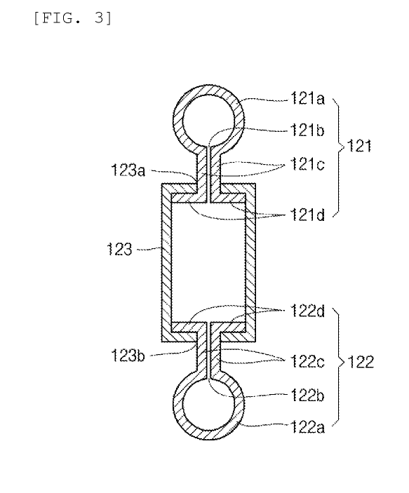

FIG. 1 is a view illustrating a state where a shock leader swivel according to a first embodiment of the present invention is coupled to a fishing line, FIG. 2 is a view illustrating the shock leader swivel in FIG. 1 and FIG. 3 is a view illustrating the swivel portion in FIG. 1.

With reference to FIGS. 1 to 3, a shock leader swivel 100 according to the first embodiment of the present invention has one end which connects to a fishing line 20 of a fishing rod 10, and the other end to which any one of a sinker (invisible), a fishing hook (invisible), artificial bait 30 is coupled, such that the fishing line 20 is prevented from being twisted and cut when fishing tackle is cast and a fish is snatched.

To this end, the shock leader swivel 100 includes a shock leader portion 110, a swivel portion 120 and a clip portion 130.

The shock leader portion 110 includes first and second coupling portions 111, 112 and an elastic body 113 so as to connect one end thereof to the fishing line 20 of the fishing rod 10.

The first coupling portion 111 is formed at one end of the shock leader portion in the shape of a ring so as to be coupled to the fishing line 20.

Herein, the fishing line 20 is knotted and coupled to the first coupling portion 111 so as not to separate from the first coupling portion.

Meanwhile, the first coupling portion 111 has a rubber-coated layer 111a on an outer circumferential surface thereof such that a frictional force between the fishing line 20 and the first coupling portion 111, and damage done to the fishing line 20 by frictional force may be minimized.

Additionally, the second coupling portion 112 is formed at the other end of the shock leader portion in the shape of a ring so as to be coupled to one end of the swivel portion 120.

The elastic body 113 is formed between the first and second coupling portions 111, 112 and is configured as a coil spring where a plurality of coils are wound so as to have a tensile force.

Herein, the tensile force of the elastic body 113 is adjusted depending on the number of windings and the thickness of a coil.

The tensile force of the elastic body 113 may be adjusted depending on the number of windings and the thickness of a coil and may be applied to various sizes of fishing rods 10 that require various tensile forces depending on the sizes of fish.

That is, the elastic body 113 is designed to have tensile forces the same as maximum tensile forces of various sorts of fishing lines and therefore may be applied to various fishing rods 10.

Additionally, the swivel portion 120 has one end which is rotatably coupled to the second coupling portion 112 of the shock leader portion 110 so as to prevent the fishing line 20 and the shock leader portion 110 from being twisted, and includes a first loop portion 121, a second loop portion 122 and a body portion 123.

The first loop portion 121 includes a first coupling rim 121a which is coupled to the second coupling portion 112 and has an opening 121b on one side thereof.

The first loop portion 121 has a pair of first insertion pins 121c that extend downwards from the opening 121b and are inserted into an upper portion of the body portion 123.

Herein, the body portion 123 has a hollow inside, and includes first and second insertion holes 123a, 123b at the upper and lower portions thereof such that the first and second loop portions 121, 122 are inserted into and coupled to the upper and lower portions of the body portion.

Additionally, the pair of first insertion pins 121c include a first escape prevention pin 121d one end of which extends inwards and is coupled to an outer edge of the first insertion hole 123a so as to prevent the first loop portion 121 from escaping from the inside of the body portion 123.

The second loop portion 122 includes a second coupling rim 122a which is coupled to one end of the clip portion 130 and has an opening 122b on one side thereof, and a pair of second insertion pins 122c that extend upwards from the opening 122b and are inserted into the second insertion hole 123b.

Additionally, the pair of second insertion pins 122c include a second escape prevention pin 122d one end of which extends inwards and is coupled to an outer edge of the second insertion hole 123b so as to prevent the second loop portion 122 from escaping from the inside of the body portion 123.

That is, the first and second loop portions 121, 122 are rotatably inserted into and coupled to the upper and lower portions of the body portion 123, and rotate at the body portion 123. Thus, the fishing line 20 is prevented from being twisted when a fish is snatched, and damage done to the fishing line 20 is prevented.

Additionally, the clip portion 130 has one end which is coupled to the second loop portion 122 of the swivel portion 120 and the other end to which any one of a sinker (invisible), a fishing hook (invisible), artificial bait 30 is coupled, and includes a first opening portion 131, a first extension portion 132, a second opening portion 133, a second extension portion 134, and an elastic portion 135.

Ends on one side of the first and second opening portions 131, 133 are configured to be coupled to and separated from each other such that the inlet and outlet of the second loop portion 122 is possible.

Additionally, the first opening portion 131 includes a catching hook 131a which is bent inwards in multiple stages such that the second opening portion 133 is coupled to and separated from the first opening portion 131.

The second opening portion 133 includes a catching hole 133a one end of which is curved outwards and is coupled to the catching hook 131a of the first opening portion 131.

Additionally, the first extension portion 132 extends from one end of the first opening portion 131 while the first extension portion stands because of a reduced perpendicular width thereof at one end of the first opening portion.

The second extension portion 134 extends from one end of the second opening portion 133 while the second extension portion stands because of a reduced perpendicular width thereof at one end of the second opening portion.

Additionally, the elastic portion 135, where the other ends of the first and second extension portions 132, 134 are connected to each other and on which the second loop portion 122 is mounted, has a round outer side so as to be elastic enough to couple the second opening portion 133 to the first opening portion 131 and separate the second opening portion from the first opening portion.

That is, the elastic portion 135 may supply elastic stress such that the second extension portion 134 is deformed, and coupled to and separated from the first opening portion 131.

Meanwhile, any one of a sinker (invisible), a fishing hook (invisible), artificial bait 30 may be coupled to the inside of the first and second opening portions 131, 133, in the state where the first and second opening portions 131, 133 are coupled through the catching hook 131a and the catching hole 133a of the clip portion 130.

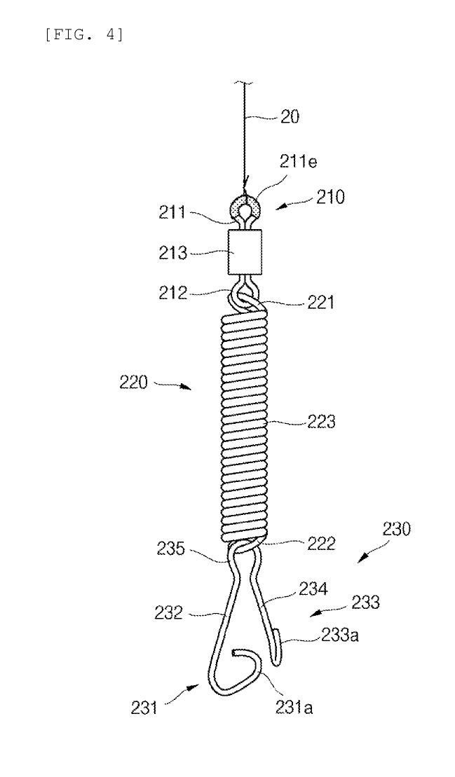

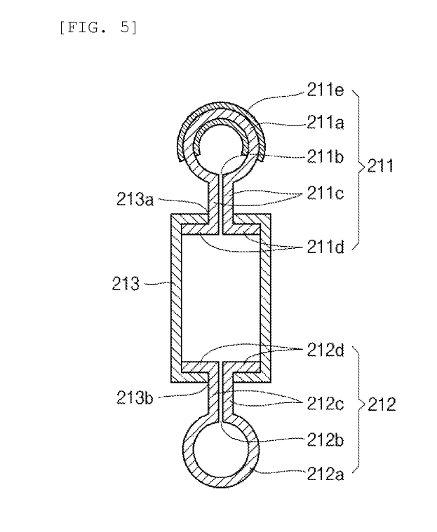

FIG. 4 is a view illustrating a shock leader swivel according to the second embodiment of the present invention, and FIG. 5 is a view illustrating the swivel portion in FIG. 4.

With reference to FIGS. 4 and 5, a shock leader swivel 200 according to the second embodiment of the present invention includes a swivel portion 210, a shock leader portion 220 and a clip portion 230.

The swivel portion 210 has one end which is rotatably coupled to the fishing line 20 of the fishing rod 10 so as to prevent the fishing line 20 from being twisted. The swivel portion 210 includes first and second loop portions 211, 212 such that one end of the swivel portion is coupled to the fishing line 20 while the other end is coupled to one end of the shock leader portion 220, and a body portion 213 between the first and second loop portions 211, 212 such that the first and second loop portions 211, 212 are rotatably inserted into and coupled to upper and lower portions of the body portion 213.

That is, the first and second loop portions 211, 212 are rotatably inserted into and coupled to the upper and lower portions of the body portion 213, and rotate at the body portion 213. Thus, the fishing line 20 is prevented from being twisted when a fish is snatched, and damage done to the fishing line 20 is prevented.

Herein, the body portion 213 has a hollow inside, and includes first and second insertion holes 213a, 213b at the upper and lower portions thereof such that the first and second loop portions 211, 212 are inserted into and coupled to the upper and lower portions of the body portion.

The first loop portion 211 that is coupled to the fishing line 20 includes a first coupling rim 211a having an opening 211b, a pair of first insertion pins 211c and a first escape prevention pin 211d. The first insertion pins 211c and the first escape prevention pin 211d are the same as the first insertion pins 121c and the first escape prevention pin 121d described in the first embodiment of the present invention. Thus, detailed description of the first insertion pins 211c and the first escape prevention pin 211d will be omitted.

Herein, the fishing line 20 is knotted and coupled to a first coupling rim 211a so as not to separate from the first coupling rim 211a.

Additionally, the first coupling rim 211a has a rubber-coated layer 211e on an outer circumferential surface thereof such that a frictional force between the fishing line 20 and the first coupling rim 211a, and damage done to the fishing line 20 by frictional force may be minimized.

Further, the second loop portion 212 to which one end of the shock leader portion 220 is coupled includes a second coupling rim 212a which has an opening 211b on one side thereof, and consists of a pair of second insertion pins 212c and a second escape prevention pin 212d. The second insertion pins 212c and the second escape prevention pin 212d are the same as the second insertion pins 122c and the second escape prevention pin 122d described in the first embodiment of the present invention. Thus, detailed description of the second insertion pins 212c and the second escape prevention pin 212d will be omitted.

The shock leader portion 220 consists of an elastic body 223 having a tensile force, and has one end coupled to the second loop portion 212 of the swivel portion 210 and the other end coupled to one end of the clip portion 230.

That is, the shock leader portion 220 is coupled to the swivel portion 210 and buffers the effect of a shock through the deformation of the elastic body 223 having a tensile force when a fish is snatched so as to prevent the fishing line 20 from being cut due to the shock.

The shock leader portion 220 consists of first and second coupling portions 221, 222 and an elastic body 223, and the first and second coupling portions 221, 222 and the elastic body 223 are the same as the first and second coupling portions 111, 112 and the elastic body 113 of the shock leader portion 110 described in the first embodiment of the present invention. Thus, detailed description of the first and second coupling portions 221, 222 and the elastic body 223 will be omitted.

Additionally, the clip portion 230, which is coupled to the second coupling portion 222 of the shock leader portion 220 and has the other end to which any one of a sinker (invisible), a fishing hook (invisible), and artificial bait 30 is coupled, includes first and second opening portions 231, 233 having a catching hook 231a and a catching hole 233a, first and second extension portions 232, 234, and an elastic portion 235. The first and second opening portions 231, 233 having a catching hook 231a and a catching hole 233a, the first and second extension portions 232, 234, and the elastic portion 235 are the same as the first and second opening portions 131, 133 having a catching hook 131a and a catching hole 133a, the first and second extension portions 132, 134, and the elastic portion 135 described in the first embodiment of the present invention. Thus, detailed description of the first and second opening portions 231, 233 having a catching hook 231a and a catching hole 233a, the first and second extension portions 232, 234, and the elastic portion 235 will be omitted.

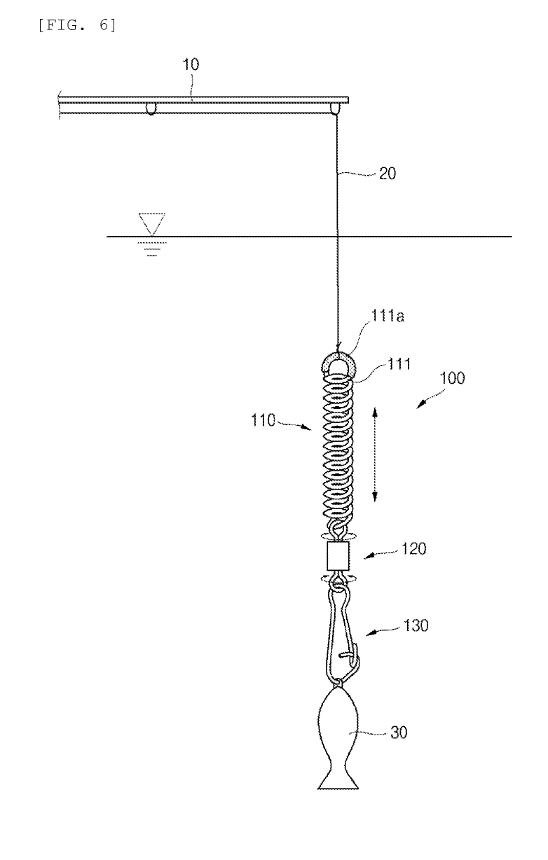

FIG. 6 is a view illustrating a state where the shock leader swivel in FIG. 1 is being used.

The state where the shock leader swivel 100 according to the first embodiment of the present invention is being used is described as follows with reference to FIG. 6.

First, a fishing line 20 of a fishing rod 10 is coupled to a first coupling portion 111 of the shock leader portion 110.

In this case, the fishing line 20 is knotted and coupled to the first coupling portion 111 so as not to separate from the first coupling portion 111.

Herein, the fishing line 20 is knotted and coupled so as not to separate from the first coupling portion 111.

Meanwhile, the first coupling portion 111 has a rubber-coated layer 111a on an outer circumferential surface thereof such that a frictional force between the fishing line 20 and the first coupling portion 111, and damage done to the fishing line 20 by frictional force may be minimized.

Additionally, a first loop portion 121 of a swivel portion 120 is coupled to a second coupling portion 112 of the shock leader portion 110, and any one of a sinker (invisible), a fishing hook (invisible), artificial bait 30 is coupled to a second loop portion 122 of the swivel portion 120 so as to prepare fishing tackle.

When a shock leader swivel 100 according to the present invention consecutively connects with the fishing line 20 as described above, the first and second loop portions 121, 122 being coupled to the swivel portion 120 rotate on the surface of the water such that the fishing line 20 rotates at the fishing rod 10, thereby preventing the fishing line 20 from twisting.

Additionally, when a fish is caught on the fishing hook (invisible) or artificial bait 30 and snatched, an elastic body 113 of the shock leader portion 110 is elastically deformed by tensile force so as to absorb the shock that happens when a fish is snatched, thereby making it possible to prevent the fishing line 20 from being cut.

As described above, according to a shock leader swivel 100, 200 of the embodiments of the present invention, a shock leader portion 110, 220 having tensile force is coupled to a fishing line 20 so as to effectively to absorb the shock that happens when a fish is snatched, thereby preventing the fishing line 20 and the shock leader portion 110, 220 from being cut.

That is, the shock leader portion 110, 220 does not need to be re-coupled to the fishing line 20 because the shock leader portion 110, 220 is not cut off from the fishing line 20, thereby making it possible to provide convenience to users.

Further, when fishing tackle is cast into the water to catch a fish, a shock leader portion 110, 220 is deformed by tensile force so as to absorb the shock that happens when fishing tackle is cast, thereby preventing the fishing line 20 from being cut.

Further, a swivel portion 120, 210, rotatably coupled to the shock leader portion 110, 220, can prevent the fishing line 20 from being twisted when a fish is snatched and prevent damage done to the fishing line 20 by the twist of the fishing line 20.

The embodiments of the present invention have been described. However, it should be understood that the present invention is not limited to the above-described embodiments but is intended to cover various modifications and equivalent arrangements, made by one of ordinary skill in the art to which the present invention pertains and included within the spirit and scope of the present invention.

*Description of the Symbols*

| | |
|---|---|
| 10: Fishing rod | 20: Fishing line |
| 30: Artificial bait | 100: Shock leader swivel |
| 110: Shock leader portion | 111: First coupling portion |
| 111a: Rubber-coated layer | 112: Second coupling portion |
| 113: Elastic body | 120: Swivel portion |
| 121: First loop portion | 121a: First coupling rim |
| 121b: Opening | 121c: First insertion pin |
| 121d: First escape prevention pin | 122: Second loop |
| | portion |
| 122a: Second coupling rim | 122b: Opening |
| 122c: Second insertion pin | 122d: Second escape prevention |
| | pin |
| 123: Body portion | 123a: First insertion hole |
| 123b: Second insertion hole | 130: Clip portion |
| 131: First opening portion | 131a: Catching hook |
| 132: First extension portion | 133: Second opening portion |
| 133a: Catching hole | 134: Second extension portion |
| 135: Elastic portion | 200: Shock leader swivel |
| 210: Swivel portion | 211: First loop portion |
| 211a: First coupling rim | 211b: Opening |
| 211c: First insertion pin | 211d: First escape prevention |
| | pin |
| 211e: Rubber-coated layer | 212: Second loop portion |
| 212a: Second coupling rim | 212b: Opening |
| 212c: Second insertion pin | 212d: Second escape prevention |
| | pin |
| 213: Body portion | 213a: First insertion hole |
| 213b: Second insertion hole | 220: Shock leader portion |
| 221: First coupling portion | 222: Second coupling portion |
| 223: Elastic body | 230: Clip portion |
| 231: First opening portion | 231a: Catching hook |
| 232: First extension portion | 233: Second opening portion |
| 233a: Catching hole | 234: Second extension portion |
| 235: Elastic portion | |

1. A shock leader swivel comprising:
a shock leader portion one end of which is coupled to a fishing line of a fishing rod and has tensile force;
a swivel portion one end of which is rotatably coupled to the other end of the shock leader portion so as to prevent the fishing line and the shock leader portion from being twisted; and
a clip portion one end of which is coupled to the swivel portion.

2. The shock leader swivel according to claim 1, wherein the shock leader portion comprises a first coupling portion so as to connect one end thereof to the fishing line, a second coupling portion so as to connect the other end thereof to one end of the swivel portion, and an elastic body having tensile force is provided between the first and second coupling portions.

3. The shock leader swivel according to claim 2, wherein the elastic body is configured as a coil spring where a plurality of coils are wound, and the tensile force of the elastic body is adjusted depending on the number of windings and the thickness of the coil.

4. The shock leader swivel according to claim 2,
the swivel portion comprising:
a first loop portion which is coupled to the second coupling portion;
a second loop portion which is coupled to one end of the clip portion; and
a body portion into which the first and second loop portions are rotatably inserted and coupled such that the first and second loop portions rotate at upper and lower portions of the body portion,
wherein the body portion has a hollow inside, and comprises first and second insertion holes at the upper and lower portions thereof such that the first and second loop portions are inserted into and coupled to the upper and lower portions of the body portion.

5. The shock leader swivel according to claim 4,
the first loop portion comprising:
a first coupling rim which is coupled to the second coupling portion and has an opening on one side thereof;
a pair of first insertion pins that extend downwards from the opening and are inserted into the first insertion hole; and
a first escape prevention pin in which one ends of the pair of first insertion pins extend inwards and are coupled to an outer edge of the first insertion hole so as to prevent the first loop portion from escaping from the inside of the body portion,
the second loop portion comprising;
a second coupling rim which is coupled to one end of the clip portion and has an opening on one side thereof;
a pair of second insertion pins which extends upwards from the opening and are inserted into the second insertion hole; and
a second escape prevention pin in which one ends of the pair of second insertion pins extend inwards and are coupled to an outer edge of the second insertion hole so as to prevent the second loop portion from escaping from the inside of the body portion.

6. The shock leader swivel according to claim 5,
the clip portion comprising:
first and second opening portions whose ends on one side thereof are coupled to and separated from each other such that the inlet and outlet of the second loop portion are possible;
a first extension portion which extends from one end of the first opening portion while the first extension portion stands because of a reduced perpendicular width thereof at one end of the first opening portion;
a second extension portion which extends from one end of the second opening portion while the second extension portion stands because of a reduced perpendicular width thereof at one end of the second opening portion; and
an elastic portion, where the other ends of the first and second extension portions are connected to each other, on which the second loop portion is mounted, and which has a round outer side so as to be elastic enough to couple the second opening portion to the first opening portion and separate the second opening portion from the first opening portion,
wherein the first opening portion comprises a catching hook which is bent inwards in multiple stages such that the second opening portion is coupled to and separated from the first opening portion, and
the second opening portion comprises a catching hole one end of which is curved outwards and is coupled to the catching hook of the first opening portion.

7. A shock leader swivel comprising:
a swivel portion one end of which is rotatably coupled to a fishing line of a fishing rod and which prevents the fishing line from being twisted;
a shock leader portion which is coupled to the other end of the swivel portion and has tensile force; and
a clip portion one end of which is coupled to the shock leader portion,
wherein the swivel portion comprises first and second loop portions such that one end of the swivel portion is coupled to the fishing line while the other end is coupled to one end of the shock leader portion, and a body portion into which the first and second loop portions are rotatably inserted into and coupled to upper and lower portions thereof and which is formed between the first and second loop portions, and
the shock leader portion comprises a first coupling portion one end of which is coupled to the second loop portion, a second coupling portion the other end of which is coupled to one end of the clip portion, and an elastic body in which a plurality of coils are wound between the first and second coupling portions and which is configured as a coil spring having tensile force.

8. The shock leader swivel according to claim 7,
wherein the body portion has a hollow inside, and comprises first and second insertion holes at the upper and lower portions thereof such that the first and second loop portions are inserted into and coupled to the first and second insertion holes,
the first loop portion comprising:
a first coupling rim which is coupled to the fishing line and has an opening on one side thereof;
a pair of first insertion pins that extend downwards from the opening and are inserted into the first insertion hole; and
a first escape prevention pin in which one ends of the pair of first insertion pins extend inwards and are coupled to an outer edge of the first insertion hole so as to prevent the first loop portion from escaping from the inside of the body portion,
the second loop portion comprising:
a second coupling rim which is coupled to the first coupling portion and has an opening on one side thereof;
a pair of second insertion pins that extend upwards from the opening and are inserted into the second insertion hole; and
a second escape prevention pin in which one ends of the pair of second insertion pins extend inwards and are coupled to an outer edge of the second insertion hole so as to prevent the second loop portion from escaping from the inside of the body portion.

9. The shock leader swivel according to claim 7,
the clip portion comprising:
first and second opening portions whose ends on one side thereof are coupled to and separated from each other such that the inlet and outlet of the second coupling portion are possible;
a first extension portion which extends from one end of the first opening portion while the first extension portion stands because of a reduced perpendicular width thereof at one end of the first opening portion;
a second extension portion which extends from one end of the second opening portion while the second extension portion stands because of a reduced perpendicular width thereof at one end of the second opening portion; and
an elastic portion, where the other ends of the first and second extension portions are connected to each other, on which the second coupling portion is mounted, and which has a round outer side so as to be elastic enough to couple the second opening portion to the first opening portion and separate the second opening portion from the first opening portion,
wherein the first opening portion comprises a catching hook which is bent inwards in multiple stages such that the second opening portion is coupled to and separated from the first opening portion, and
the second opening portion comprises a catching hole one end of which is curved outwards and is coupled to the catching hook of the first opening portion.
